(19) United States
(12) Patent Application Publication
(10) Pub. No.: US 2026/0128510 A1
(43) Pub. Date: May 7, 2026

(54) FINE TUNING FOR COLLIMATOR ANTENNA DEVICES

(71) Applicant: QUALCOMM Incorporated, San Diego, CA (US)

(72) Inventors: Rahul MALIK, San Diego, CA (US); Yu-Chin OU, San Diego, CA (US); Jun ZHU, San Diego, CA (US); Raghu Narayan CHALLA, San Diego, CA (US)

(21) Appl. No.: 18/937,731

(22) Filed: Nov. 5, 2024

(51) Int. Cl. H01Q 3/14; H01Q 3/26

(52) U.S. Cl. CPC H01Q 3/14; H01Q 3/2658

(57) ABSTRACT

Methods, systems, and devices for wireless communications are described. A wireless device may support a collimator (e.g., a reflector antenna or lens) with an aperture large enough to support multiple beams (e.g., instead of a single beam). The wireless device may perform electronic measurements (e.g., may dither across multiple beams using the phased antenna array supported by the large aperture) and fine tuning of the beam. For example, the wireless device may receive reference signals during one or more measurement opportunities via multiple beams. The wireless device may determine a preferred (e.g., different) beam based on the measurements, without yet having actually changed a physical orientation of the wireless device. Having identified a preferred beam, the wireless device may mechanically adjust its orientation towards the preferred beam (e.g., and the preferred beam may in fact support improved or more reliable wireless communications as indicated by the electronic measurements).

### FIELD OF TECHNOLOGY

The following relates to wireless communications, including fine tuning for collimator antenna devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a device is described. The method may include receiving one or more reference signals using a collimator at the device having an aperture size sufficient to support simultaneous reception via a first beam corresponding to a first direction and at least a second beam corresponding to a second direction, electronically performing one or more measurements for the one or more reference signals via the first beam and at least the second beam based on the aperture size of the collimator, and mechanically adjusting an orientation of the collimator toward the second direction corresponding to the second beam based on the one or more measurements.

A device for wireless communications is described. The device may include one or more memories storing processor executable code, and one or more processors coupled with the one or more memories. The one or more processors may individually or collectively be operable to execute the code to cause the device to receive one or more reference signals using a collimator at the device having an aperture size sufficient to support simultaneous reception via a first beam corresponding to a first direction and at least a second beam corresponding to a second direction, electronically perform one or more measurements for the one or more reference signals via the first beam and at least the second beam based on the aperture size of the collimator, and mechanically adjust an orientation of the collimator toward the second direction corresponding to the second beam based on the one or more measurements.

Another device for wireless communications is described. The device may include means for receiving one or more reference signals using a collimator at the device having an aperture size sufficient to support simultaneous reception via a first beam corresponding to a first direction and at least a second beam corresponding to a second direction, means for electronically performing one or more measurements for the one or more reference signals via the first beam and at least the second beam based on the aperture size of the collimator, and means for mechanically adjusting an orientation of the collimator toward the second direction corresponding to the second beam based on the one or more measurements.

A non-transitory computer-readable medium storing code for wireless communications is described. The code may include instructions executable by one or more processors to receive one or more reference signals using a collimator at the device having an aperture size sufficient to support simultaneous reception via a first beam corresponding to a first direction and at least a second beam corresponding to a second direction, electronically perform one or more measurements for the one or more reference signals via the first beam and at least the second beam based on the aperture size of the collimator, and mechanically adjust an orientation of the collimator toward the second direction corresponding to the second beam based on the one or more measurements.

In some examples of the method, devices, and non-transitory computer-readable medium described herein, mechanically adjusting the orientation of the collimator may include operations, features, means, or instructions for actuating a multi-axis rotating platform to rotate from a first position directed towards the first beam to a second position directed towards the second beam.

In some examples of the method, devices, and non-transitory computer-readable medium described herein, receiving the one or more reference signals may include operations, features, means, or instructions for dithering an illuminating beam across the first beam and at least the second beam during a measurement opportunity corresponding to the one or more reference signals based on the aperture size of the collimator.

In some examples of the method, devices, and non-transitory computer-readable medium described herein, electronically performing one or more measurements may include operations, features, means, or instructions for changing a direction of an illuminating beam to correspond to the first beam and at least the second beam over time during one or more measurement opportunities corresponding to the one or more reference signals and determining a gradient of measurement improvement from the first direction to the second direction based on the one or more measurements, where mechanically adjusting the orientation of the device may be based on the gradient of measurement improvement.

In some examples of the method, devices, and non-transitory computer-readable medium described herein, the one or more measurements include reference signal receive power measurements.

In some examples of the method, devices, and non-transitory computer-readable medium described herein, the gradient of measurement improvement includes a set of measurement values, corresponding to respective beams of a set of multiple beams, corresponding to the device resulting from the one or more measurements, and the set of measurement values improve when ordered from measurements corresponding to the first beam to measurements corresponding to the second beam.

In some examples of the method, devices, and non-transitory computer-readable medium described herein, changing the direction of the illuminating beam may include operations, features, means, or instructions for steering the illuminating beam via one or more subsets of antenna elements an antenna array at the device.

In some examples of the method, devices, and non-transitory computer-readable medium described herein, the one or more reference signals include one or more synchronization signal blocks, or one or more channel state information reference signals.

Some examples of the method, devices, and non-transitory computer-readable medium described herein may further include operations, features, means, or instructions for receiving one or more additional reference signals while the collimator may be oriented toward the second direction, electronically performing one or more additional measurements for the one or more additional reference signals via the second beam and at least a third beam corresponding to a third direction based on the collimator, and refraining from mechanically adjusting the orientation of the collimator toward the third direction corresponding to the third beam based on the one or more additional measurements.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports fine tuning for collimator antenna devices in accordance with one or more aspects of the present disclosure.

FIG. 2 shows an example of a wireless communications system that supports fine tuning for collimator antenna devices in accordance with one or more aspects of the present disclosure.

FIG. 3 shows an example of a process flow that supports fine tuning for collimator antenna devices in accordance with one or more aspects of the present disclosure.

FIGS. 4 and 5 show block diagrams of devices that support fine tuning for collimator antenna devices in accordance with one or more aspects of the present disclosure.

FIG. 6 shows a block diagram of a communications manager that supports fine tuning for collimator antenna devices in accordance with one or more aspects of the present disclosure.

FIG. 7 shows a diagram of a system including a device that supports fine tuning for collimator antenna devices in accordance with one or more aspects of the present disclosure.

FIGS. 8 through 10 show flowcharts illustrating methods that support fine tuning for collimator antenna devices in accordance with one or more aspects of the present disclosure.

### DETAILED DESCRIPTION

A wireless device may support or include a collimator for wireless communications. For instance, the wireless device may include a reflector antenna. Based on a size of an aperture of the reflector, the wireless device may be capable of receiving signaling via a single beam. The reflector antenna may be collated with or mounted on a mechanical system for physically reorienting the reflector antenna in different directions (e.g., to identify and utilize a preferred or best beam). However, if the wireless device blindly reorients to identify a better beam, the wireless device may experience interruptions to wireless communications via a current beam. Further, the wireless device may switch directions to receive or send wireless signaling via another beam, but without a mechanism to predetermine which beam is preferred, the change in direction may result in a decrease in a quality of wireless signaling (e.g., instead of an improvement).

The wireless device may also support a phased antenna array. According to techniques described herein, the wireless device may support a collimator (e.g., reflector antenna) with an aperture large enough to support multiple beams (e.g., instead of a single beam). The wireless device may perform electronic measurements (e.g., may dither across multiple beams using the phased antenna array supported by the large aperture) and fine tuning of the beam. For example, the wireless device may receive reference signals during one or more measurement opportunities via multiple beams. The wireless device may determine a preferred (e.g., different) beam based on the measurements, without yet having actually changed a physical orientation of the wireless device. Having identified a preferred beam, the wireless device may mechanically adjust its orientation towards the preferred beam (e.g., and the preferred beam may in fact support improved or more reliable wireless communications as indicated by the electronic measurements). Such techniques may result in effective identification and orientation towards preferred beams, without interruptions to a wireless link due to blind mechanical redirection by the wireless device, or without random selection of candidate beams that may or may not actually support improved wireless communications. Such techniques may thus result in more reliable wireless communications, less interruptions to a wireless link, improved throughput, and improved user experience.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to fine tuning for collimator antenna devices.

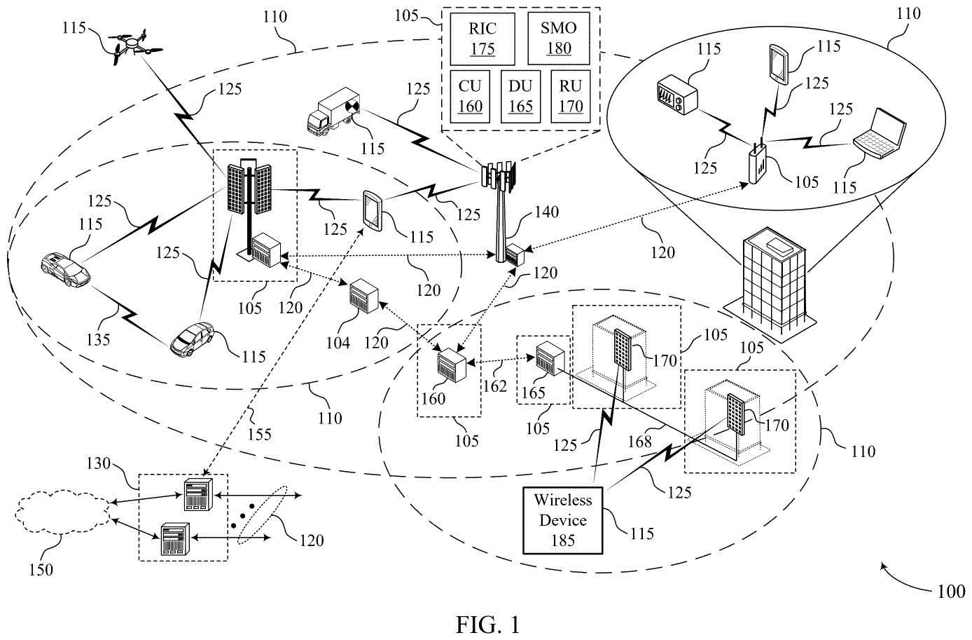

FIG. 1 shows an example of a wireless communications system 100 that supports fine tuning for collimator antenna devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support fine tuning for collimator antenna devices as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may include a wireless device 185. The wireless device 185 may be a UE 115, a network entity 105, a satellite dish, or any other wireless device. The wireless device 185 may support or include a collimator (e.g., a reflector, a lens, etc.). According to techniques described herein, the wireless device 185 may support a collimator (e.g., reflector antenna) with an aperture large enough to support multiple beams (e.g., instead of a single beam). The wireless device 185 may perform electronic measurements (e.g., may dither across multiple beams using the phased antenna array supported by the large aperture) and fine tuning of the beam. For example, the wireless device 185 may receive reference signals during one or more measurement opportunities via multiple beams. The wireless device 185 may determine a preferred (e.g., different) beam based on the measurements, without yet having actually changed a physical orientation of the wireless device 185. Having identified a preferred beam, the wireless device 185 may mechanically adjust its orientation towards the preferred beam (e.g., and the preferred beam may in fact support improved or more reliable wireless communications as indicated by the electronic measurements).

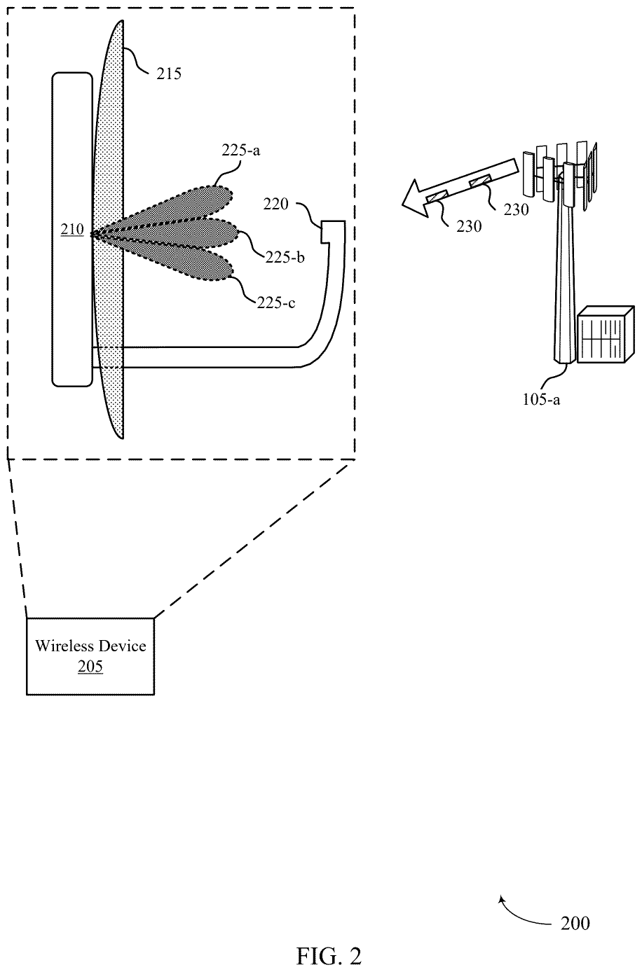

FIG. 2 shows an example of a wireless communications system 200 that supports fine tuning for collimator antenna devices in accordance with one or more aspects of the present disclosure. The wireless communications system 200 may implement, or be implemented by, aspects of the wireless communications system 100. For example, the wireless communications system 200 may include one or more wireless devices, such as the wireless device 205 (e.g., an example of a wireless device 185) and the network entity 105-a, which may be examples of corresponding devices described with reference to the wireless communications system 100. The wireless device 205 may include one or more reflector antennas. A reflector antenna may include a reflector 215 that supports reception at a focal point (e.g., a receiver 220). The receiver 220 may be referred to as a feed, an illuminating feed, or a phased antenna array, among other examples. The wireless device 205 may be an example of a satellite dish, or any other wireless device (e.g., a UE, a reflector, a RIS, a network entity, a wireless node, among other examples).

The wireless device 205 may include a reflector 215. The reflector 215 may direct received signaling or beams (e.g., beams 225) towards a receiver 220. For example, the wireless device 205 may include one or more antenna apparatuses. In some examples, the antenna apparatus may include a reflector 215 and one or more antenna panels (e.g., or antenna arrays). The reflector 215 may direct received signaling towards a receiver such as an antenna array or an antenna panel. In some examples, the wireless device 205 may include, be collocated with, or mounted on, an apparatus 210. The apparatus 210 may include or may be a multi-axis rotating platform, which may be capable of rotating from a first position to another position (e.g., changing a direction or orientation of the reflector 215 and the receiver 220). For example, the apparatus 210 be a mechanical (e.g., mechanized or motorized) platform controlled by or directed by the wireless device 205.

In some examples, a wireless device (e.g., such as a wireless device 205) may support phased array antenna systems. Such systems may be used to achieve tunable directionality (e.g., the ability to steer one or more beams 225 in different directions), tunable gains (e.g., by using different numbers of antenna elements to synthesize a beam 225, steer a beam 225, or change a beam width), or the like. Larger phased arrays may be realized by stacking tiles of smaller phased arrays, which may be suitably designed to maintain antenna elements spacing in the stacked arrangement. In some examples, due to power costs or thermal costs, among other examples, a large phased array may not be suitable for a given design. One way to overcome the loss in antenna gain due to a smaller array may be to augment a smaller array (e.g., such as the receiver 220) with a suitably shaped reflector 215. An improved (e.g., optimal) feed for the reflector-based design may be an isotropic point source placed at a focal point (e.g., an antenna array, such as the receiver 220, may be located at a focal point of the reflector 215). In some designs, devices may use a small phased array (e.g., a single tile at the receiver 220) to serve as a feed to a reflector based design.

Reflector-based antennas may be associated with fixed beam systems. For example, the reflector may constrain tunable directionality of a phased array, which may render a fixed beam pattern with a high gain. For instance, given an aperture size of the apparatus (e.g., the reflector 215 and the receiver 220), the wireless device 205 may be able to receive signaling via the beam 225-b (e.g., but not the beam 225-a or the beam 225-c) in a given orientation of the apparatus 210. Reflector antennas may overcome such limitations by employing the use of an apparatus 210 (e.g., a multi-axis motor/gimbal system). That is, the wireless device may utilize the apparatus 210 to reorient a direction of the reflector antenna to receive signaling (e.g., from the network entity 105-a) via other beams 225 (e.g., from other directions). However, such systems (e.g., that rely on the mechanical or physical reorientation of the reflector antenna) may suffer from disadvantages including a lower reliability of a mechanical system, higher latency based on motor speed, limited degrees of freedom owing to motor step size, or the like.

Mechanical dithering of a reflector antenna to measure if there are better (e.g., adjacent) directions for receiving wireless signaling may result in an impact to one or more link metrics (e.g., reference signal receiver power (RSRP), throughput, etc.) on the best serving direction. For instance, the wireless device 205 may have an antenna aperture (e.g., corresponding to the reflector 215) sufficient to support a single beam at a time (e.g., the wireless device 205 may be capable of receiving wireless signaling via one beam 225-b when at a particular orientation of the apparatus 210). In such examples, the wireless device 205 may experience a cost of performing measurements which may or may not yield an improvement to the serving link direction. For example, the wireless device 205 may receive signaling (e.g., from the network entity 105-a). For instance, the wireless device 205 may receive one or more reference signals 230 (e.g., synchronization signal block (SSB), channel state information (CSI) reference signals (RSs), etc.) via the beam 225-b. Over time, wireless communications channels may change. For instance, a blockage may appear that limits signaling via the beam 225-b, the wireless device 205 may move, or the like. In such examples, communications via the beam 225-b may suffer.

The wireless device 205 may reorient the reflector antenna (e.g., towards the beam 225-c) to improve the quality of wireless communications. The wireless device 205 may monitor for one or more reference signals 230 via the beam 225-c. Monitoring for reference signals 230 via the beam 225-c may result in failure to receive any wireless communications via the beam 225-b. Further, if the beam 225-c is not in fact better than the beam 225-b (e.g., if wireless communications received via the beam 225-c do not result in improved reception, reliability, or throughput), then the wireless device 205 may suffer a decreased quality of wireless signaling (e.g., may fail to receive some or all of wireless signaling via the beam 225-b) without having identified a direction (e.g., the beam 225-c) that will result in improved quality of wireless communications. In such examples of mechanical reorientation to (e.g., blindly) attempt to identify improved directions for wireless communications, the device 205 may experience a high cost to the quality of wireless communications, without a high likelihood of identifying a different beam 225 via which to perform wireless communications. Thus, determining an improved direction for reception based solely on the mechanical capabilities of the apparatus 210 may be inefficient. For instance, by performing mechanical fine tuning of a serving beam, throughput may drop, the wireless device may experience poor convergence of network drive metrics such as MCS selection.

Techniques described herein may support electronic beam steering to identify a preferred (e.g., best) beam 225 (e.g., without mechanical reorientation via the apparatus 210), and subsequent mechanical reorientation in the direction of the detected preferred beam. For example, the wireless device 205 may support a reflector antenna with a larger aperture reflector 215 than is needed for an illuminating feed (e.g., the receiver 220). That is, the reflector 215 may support an aperture size sufficient to support simultaneous reception via at least a first beam corresponding to a first direction and at least a second beam corresponding to a second direction. Such an aperture size may be large enough to support more beams than a single beam 225. The wireless device 205 may dither an illuminating beam on the reflector 215 during measurement opportunities (e.g., to measure reference signals 230, such as SSBs, CSI-RSs, etc.). By electronically adjusting a beam direction during measurement opportunities (e.g., and performing one or more measurements of multiple candidate alternative beams 225 without mechanically reorienting the reflector antenna), the wireless device 205 may perform fine tuning decisions via electronic steering (e.g., as opposed to mechanical means).

For example, the wireless device 205 may electronically dither an illuminating beam 225 (e.g., from the beam 225-a, to the beam 225-b, to the beam 225-c during a measurement opportunity. The wireless device 205 may receive one or more reference signals 230 during the measurement opportunities via multiple beams 225. The wireless device may perform measurements on the beams 225 based on the received reference signals 230. The wireless device may determine (e.g., without having mechanically adjusted the orientation of the reflector antenna, and without having failed to receive signaling via the beam 225-b) that another beam 225 (e.g., the beam 225-a) is corresponds to better measurement values (e.g., higher RSRP). In such examples, having detected the improved beam 225-c via electronic measurements, the wireless device 205 may mechanically adjust its orientation (e.g., via the apparatus 210) to orient the reflector antenna towards the preferred beam 225-c. Such techniques may result in fine tuning and tracking of channel changes without impairing the serving wireless link, and improved performance and stability of the wireless link. Such techniques may support improved performance without interrupted service or failed communications that would otherwise result from purely mechanical means of scanning for and identifying updated beams 225. Such techniques and advantages may be realized based on a phased array feed (e.g., as opposed to other types of feeds, such as horn feeds or receivers).

In some examples, the beam dithering may be supported by a phased array at the receiver 220, and an aperture of the reflector 215 (e.g., and resulting properties of focal volume of the reflector 215). In some examples, the reflector 215 may correspond to a parabola, and the receiver 220 may be located at a single focal point of the parabolic reflector 215. In some examples, the reflector 215 may correspond to a circular or spherical curvature, resulting in a focal volume (e.g., a three dimensional focal area instead of a single focal point) In some examples, the reflector 215 may result in a mixed curvature for receiving signaling via a beam 225. In some examples, the reflector 215 (e.g., a spherical shape) may result in a spherical curvature axis due to properties of focal volume. The wireless device 205 may therefore dither beams 225 along the curvature axis (e.g., the spherical curvature axis) due to the properties of focal volume, allowing the receiver to receive wireless signaling via multiple beams 225 without mechanically reorienting the reflector antenna.

Techniques described herein may support a larger reflector 215 compared to a serving beam 225 (e.g., a large enough reflector 215 to serve multiple beams 225 via a focal volume, instead of a single beam 225 via a focal point). The wireless device 205 may thus support phased array beam steering from the feed onto the reflector antenna. The device may control the direction of an illuminating beam during measurement opportunities electronically, to determine a direction or gradient of RSRP improvement. For instance, the wireless device may dither across the beam 225-a, the beam 225-b, and the beam 225-c during one or more measurement opportunities. The wireless device 205 may measure reference signals 230 during the measurement opportunities via the beam 225-a, the beam 225-b, and the beam 225-c. The wireless device 205 may determine a gradient of RSRP measurements, and a direction for fine tuning the beam 225 based on the measurements, For example, the wireless device 205 may determine that the RSRP measurements improve across the dithered beams 225 (e.g., from worst RSRP measurements corresponding to the beam 225-a to best RSRP measurements corresponding to the beam 225-c). In such examples, the wireless device 205 may mechanically reorient the reflector antenna (e.g., via the apparatus 210) in the direction of the gradient towards the best measurements (e.g., towards the beam 225-c). For instance, the wireless device 205 may actuate a rotating platform to re-orient the reflector 215. Techniques described herein apply to any collimator, such as a reflector 215, a lens, etc.

Thus, according to techniques described herein, the wireless device 205 may establish the gradient or direction of fine tuning by making electronically steered measurements during the measurement duration, without impairing data transmission in the serving direction while making the measurements. Such techniques may be used in a multi-axis rotational platform with or without additional degrees of steering and beam management.

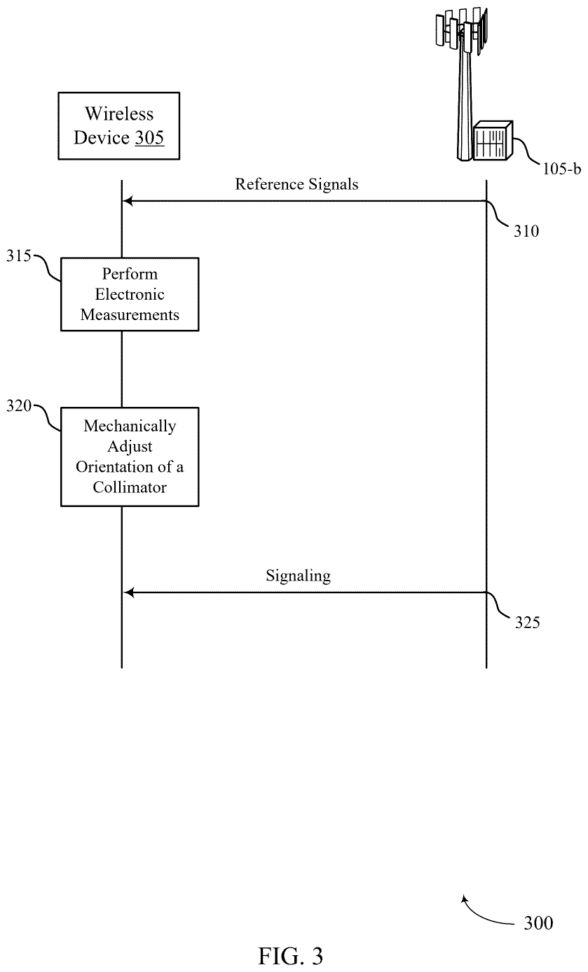

FIG. 3 shows an example of a process flow 300 that supports fine tuning for collimator antenna devices in accordance with one or more aspects of the present disclosure. The process flow 300 may implement, or be implemented by, aspects of the wireless communications system 100 and the wireless communications system 200. For example, the process flow 300 may include a wireless device 305 (e.g., which may be an example of a corresponding device, such as the wireless device 205, a UE 115, a network entity 105, a satellite dish, a wireless node, or the like), and a network entity 105-b (e.g., which may be an example of a network entity 105-a), which may be examples of corresponding devices described with reference to FIGS. 1-2.

At 310, the wireless device 305 may receive one or more reference signals (e.g., from the network entity 105-b, or another wireless device). The reference signals may be SSBs, CSI-RSs, or the like. The wireless device 305 may receive the reference signals via a first beam. The wireless device 305 may utilize a collimator (e.g., a lens or a reflector antenna) having an aperture size sufficient to support simultaneous reception via a first beam corresponding to a first direction and at least a second beam corresponding to a second direction (e.g., or any number of beams pointed any number of directions).

At 315, the wireless device 305 may perform one or more electronic measurements. The wireless device 305 may perform the measurements for the one or more reference signals via the first beam, and at least the second beam based on the aperture size of the collimator. The wireless device 305 may support a phased antenna array and an aperture size that makes the electronic measurements via multiple beams possible. For example, the wireless device 305 may dither an illuminating beam across the first beam and at least the second beam during a measurement opportunity corresponding to the one or more reference signals based at least in part on the aperture size of the collimator.

In some examples, the wireless device 305 may change a direction of the illuminating beam to correspond to the first beam and at least the second beam over time during one or more measurement opportunities corresponding to the one or more reference signals. Changing a direction of the illuminating beam may include steering the illuminating beam via one or more subsets of antenna elements at an antenna array of the wireless device 305. For instance, the wireless device 305 may control the direction of the illuminating beam at the reflector by adjusting the subset of elements on the feed array to synthesize beams in multiple directions. In some examples, the wireless device 305 may control the level of the beam illuminating the reflector by adjusting the number of elements that are used on the feed beam. The wireless device 305 may also determine a gradient of measurement improvement from the first direction to the second direction based at least in part on the one or more measurements, wherein mechanically adjusting the orientation of the device is based at least in part on the gradient of measurement improvement. In some cases, the measurements may include one or more RSRP measurements. The gradient of measurement improvement may include a set of measurement values, corresponding to respective beams, corresponding to the wireless device 305 resulting from the one or more measurements. The set of measurement values may improve when ordered from measurements corresponding to the first beam to measurements corresponding to the second beam, inditing that the second beam is a preferred (e.g., best beam) when compared to the current beam.

At 320, the wireless device 305 may mechanically adjust an orientation of a collimator (e.g., a reflector antenna, a reflector, such as the reflector 215, or a lens, etc.). The wireless device 305 may mechanically adjust the orientation towards the second direction corresponding to the second beam based on the one or more measurements. For example, the wireless device 305 may actuate a multi-axis rotating platform to rotate from a first position directed towards the first beam to a second position directed towards the second beam.

In some cases, if the measurements do not indicate that other beams are preferred (e.g., better than the current beam), the wireless device 305 may not adjust the orientation of the collimator. For example, the wireless device 305 may receive one or more additional reference signals, may electronically perform one or more additional measurements for the one or more additional reference signals, and may refrain from mechanically adjusting the orientation of the collimator towards another direction based on the additional measurements.

At 325, the wireless device 305 may receive signaling. If the wireless device 305 has mechanically adjusted the orientation of the collimator at 320, then the wireless device 305 may receive the signaling (e.g., downlink wireless signaling) via the new beam (e.g., the second beam). If the wireless device 305 did not adjust the orientation of the collimator at 320, then the wireless device 305 may receive the signaling via the previously utilized beam (e.g., in the previously utilized orientation).

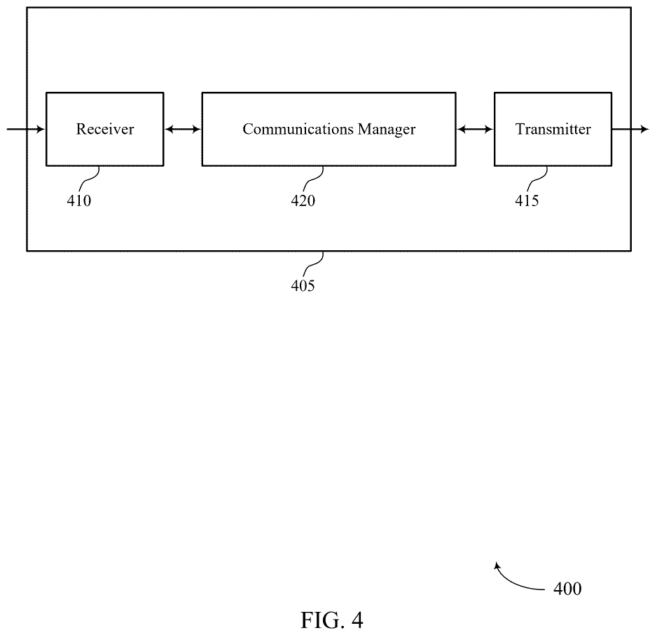

FIG. 4 shows a block diagram 400 of a device 405 that supports fine tuning for collimator antenna devices in accordance with one or more aspects of the present disclosure. The device 405 may be an example of aspects of a wireless device as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to fine tuning for collimator antenna devices). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to fine tuning for collimator antenna devices). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of fine tuning for collimator antenna devices as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving one or more reference signals using a collimator at the device having an aperture size sufficient to support simultaneous reception via a first beam corresponding to a first direction and at least a second beam corresponding to a second direction. The communications manager 420 is capable of, configured to, or operable to support a means for electronically performing one or more measurements for the one or more reference signals via the first beam and at least the second beam based on the aperture size of the collimator. The communications manager 420 is capable of, configured to, or operable to support a means for mechanically adjusting an orientation of the collimator toward the second direction corresponding to the second beam based on the one or more measurements.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for electronic beam measurement and fine tuning for a reflector antenna, which may result in improved throughput, more reliable wireless communications, more reliable wireless links with less interruptions, and improved user experience.

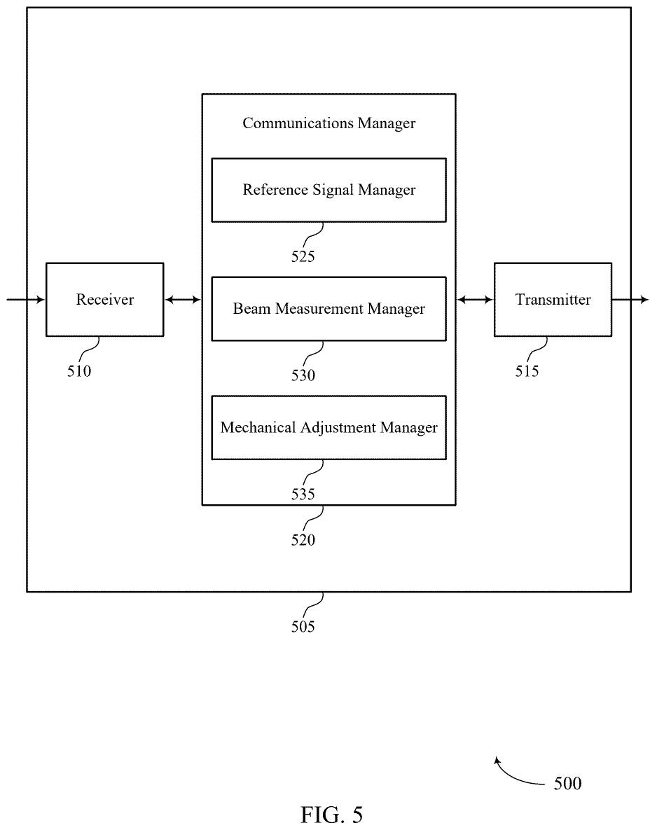

FIG. 5 shows a block diagram 500 of a device 505 that supports fine tuning for collimator antenna devices in accordance with one or more aspects of the present disclosure. The device 505 may be an example of aspects of a device 405 or a wireless device as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to fine tuning for collimator antenna devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to fine tuning for collimator antenna devices). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of fine tuning for collimator antenna devices as described herein. For example, the communications manager 520 may include a reference signal manager 525, a beam measurement manager 530, a mechanical adjustment manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The reference signal manager 525 is capable of, configured to, or operable to support a means for receiving one or more reference signals using a collimator at the device having an aperture size sufficient to support simultaneous reception via a first beam corresponding to a first direction and at least a second beam corresponding to a second direction. The beam measurement manager 530 is capable of, configured to, or operable to support a means for electronically performing one or more measurements for the one or more reference signals via the first beam and at least the second beam based on the aperture size of the collimator. The mechanical adjustment manager 535 is capable of, configured to, or operable to support a means for mechanically adjusting an orientation of the collimator toward the second direction corresponding to the second beam based on the one or more measurements.

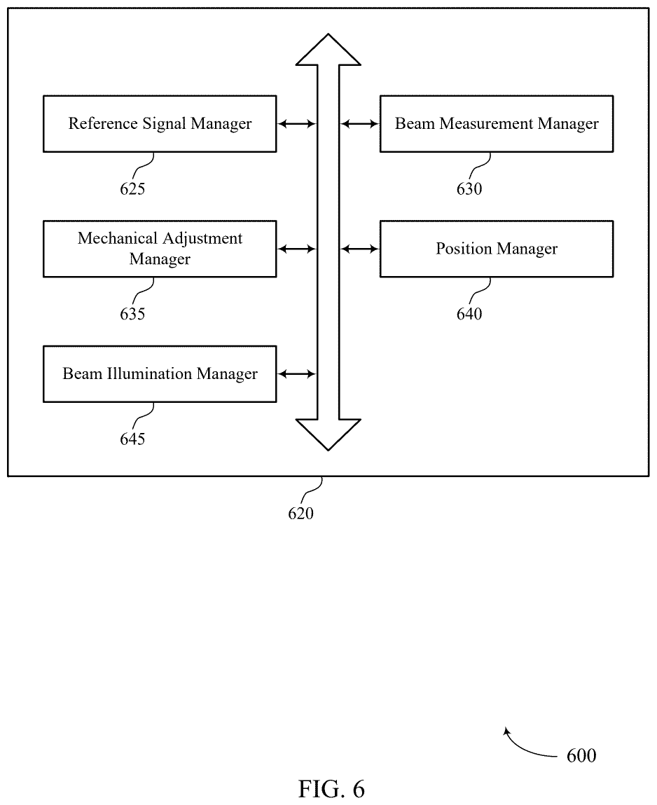

FIG. 6 shows a block diagram 600 of a communications manager 620 that supports fine tuning for collimator antenna devices in accordance with one or more aspects of the present disclosure. The communications manager 620 may be an example of aspects of a communications manager 420, a communications manager 520, or both, as described herein. The communications manager 620, or various components thereof, may be an example of means for performing various aspects of fine tuning for collimator antenna devices as described herein. For example, the communications manager 620 may include a reference signal manager 625, a beam measurement manager 630, a mechanical adjustment manager 635, a position manager 640, a beam illumination manager 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The reference signal manager 625 is capable of, configured to, or operable to support a means for receiving one or more reference signals using a collimator at the device having an aperture size sufficient to support simultaneous reception via a first beam corresponding to a first direction and at least a second beam corresponding to a second direction. The beam measurement manager 630 is capable of, configured to, or operable to support a means for electronically performing one or more measurements for the one or more reference signals via the first beam and at least the second beam based on the aperture size of the collimator. The mechanical adjustment manager 635 is capable of, configured to, or operable to support a means for mechanically adjusting an orientation of the collimator toward the second direction corresponding to the second beam based on the one or more measurements.

In some examples, to support mechanically adjusting the orientation of the collimator, the position manager 640 is capable of, configured to, or operable to support a means for actuating a multi-axis rotating platform to rotate from a first position directed towards the first beam to a second position directed towards the second beam.

In some examples, to support receiving the one or more reference signals, the beam measurement manager 630 is capable of, configured to, or operable to support a means for dithering an illuminating beam across the first beam and at least the second beam during a measurement opportunity corresponding to the one or more reference signals based on the aperture size of the collimator.

In some examples, to support electronically performing one or more measurements, the beam illumination manager 645 is capable of, configured to, or operable to support a means for changing a direction of an illuminating beam to correspond to the first beam and at least the second beam over time during one or more measurement opportunities corresponding to the one or more reference signals. In some examples, to support electronically performing one or more measurements, the beam measurement manager 630 is capable of, configured to, or operable to support a means for determining a gradient of measurement improvement from the first direction to the second direction based on the one or more measurements, where mechanically adjusting the orientation of the device is based on the gradient of measurement improvement.

In some examples, the one or more measurements include reference signal receive power measurements.

In some examples, the gradient of measurement improvement includes a set of measurement values, corresponding to respective beams of a set of multiple beams, corresponding to the device resulting from the one or more measurements, and the set of measurement values improve when ordered from measurements corresponding to the first beam to measurements corresponding to the second beam.

In some examples, to support changing the direction of the illuminating beam, the beam illumination manager 645 is capable of, configured to, or operable to support a means for steering the illuminating beam via one or more subsets of antenna elements an antenna array at the device.

In some examples, the one or more reference signals include one or more synchronization signal blocks, or one or more channel state information reference signals.

In some examples, the reference signal manager 625 is capable of, configured to, or operable to support a means for receiving one or more additional reference signals while the collimator is oriented toward the second direction. In some examples, the beam measurement manager 630 is capable of, configured to, or operable to support a means for electronically performing one or more additional measurements for the one or more additional reference signals via the second beam and at least a third beam corresponding to a third direction based on the collimator. In some examples, the mechanical adjustment manager 635 is capable of, configured to, or operable to support a means for refraining from mechanically adjusting the orientation of the collimator toward the third direction corresponding to the third beam based on the one or more additional measurements.

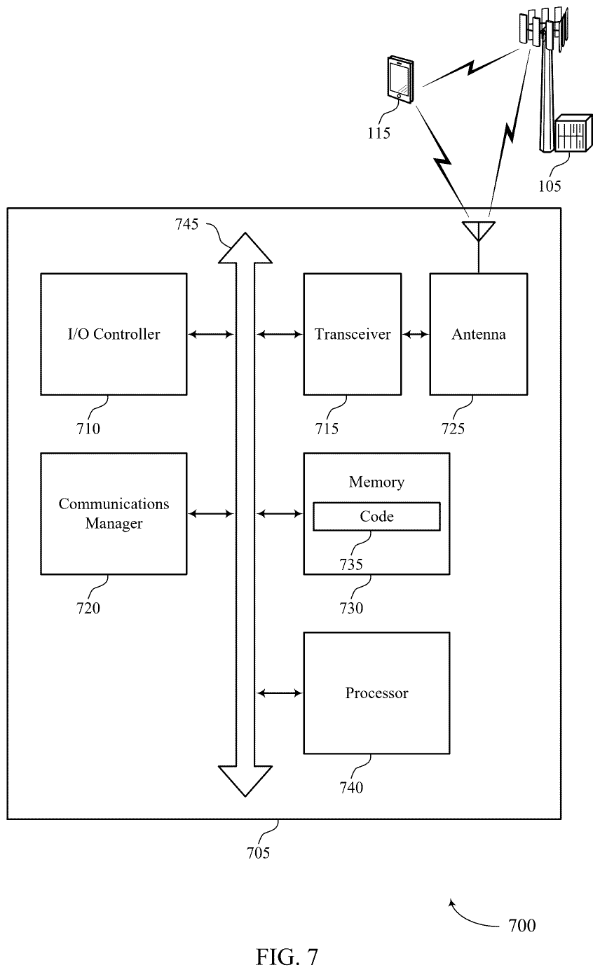

FIG. 7 shows a diagram of a system 700 including a device 705 that supports fine tuning for collimator antenna devices in accordance with one or more aspects of the present disclosure. The device 705 may be an example of or include components of a device 405, a device 505, or a wireless device as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting fine tuning for collimator antenna devices). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving one or more reference signals using a collimator at the device having an aperture size sufficient to support simultaneous reception via a first beam corresponding to a first direction and at least a second beam corresponding to a second direction. The communications manager 720 is capable of, configured to, or operable to support a means for electronically performing one or more measurements for the one or more reference signals via the first beam and at least the second beam based on the aperture size of the collimator. The communications manager 720 is capable of, configured to, or operable to support a means for mechanically adjusting an orientation of the collimator toward the second direction corresponding to the second beam based on the one or more measurements.

By including or configuring the communications manager 720 in accordance with examples as described herein, the device 705 may support techniques for electronic beam measurement and fine tuning for a reflector antenna, which may result in improved throughput, more reliable wireless communications, improved coordination between devices, decreased system latency, more reliable wireless links with less interruptions, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of fine tuning for collimator antenna devices as described herein, or the at least one processor 740 and the at least one memory 730 may be otherwise configured to, individually or collectively, perform or support such operations.

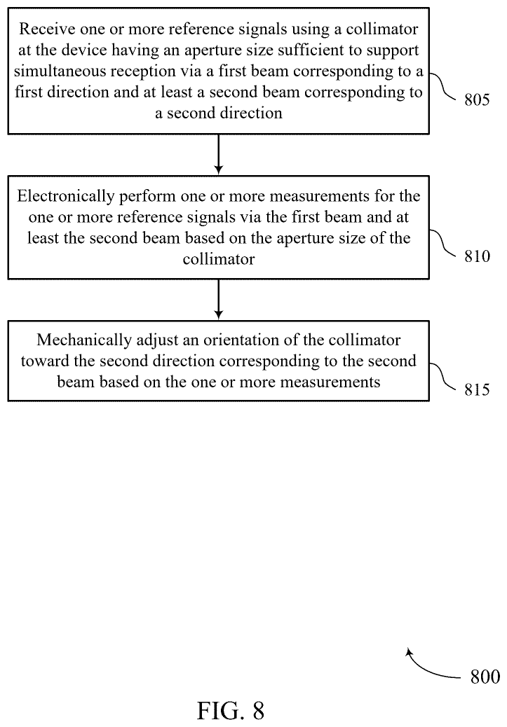

FIG. 8 shows a flowchart illustrating a method 800 that supports fine tuning for collimator antenna devices in accordance with one or more aspects of the present disclosure. The operations of the method 800 may be implemented by a wireless device or its components as described herein. For example, the operations of the method 800 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 805, the method may include receiving one or more reference signals using a collimator at the device having an aperture size sufficient to support simultaneous reception via a first beam corresponding to a first direction and at least a second beam corresponding to a second direction. The operations of 805 may be performed in accordance with examples as disclosed herein. In some examples, aspects of the operations of 805 may be performed by a reference signal manager 625 as described with reference to FIG. 6.

At 810, the method may include electronically performing one or more measurements for the one or more reference signals via the first beam and at least the second beam based on the aperture size of the collimator. The operations of 810 may be performed in accordance with examples as disclosed herein. In some examples, aspects of the operations of 810 may be performed by a beam measurement manager 630 as described with reference to FIG. 6.

At 815, the method may include mechanically adjusting an orientation of the collimator toward the second direction corresponding to the second beam based on the one or more measurements. The operations of 815 may be performed in accordance with examples as disclosed herein. In some examples, aspects of the operations of 815 may be performed by a mechanical adjustment manager 635 as described with reference to FIG. 6.

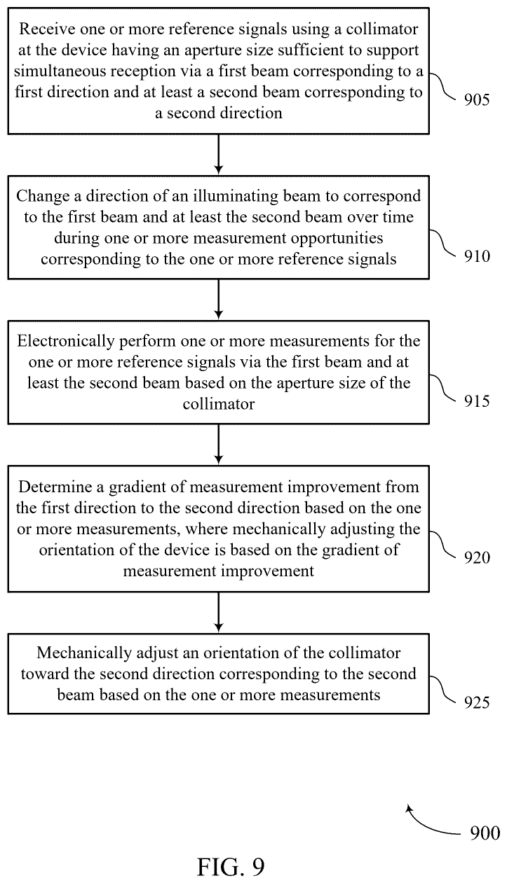

FIG. 9 shows a flowchart illustrating a method 900 that supports fine tuning for collimator antenna devices in accordance with one or more aspects of the present disclosure. The operations of the method 900 may be implemented by a wireless device or its components as described herein. For example, the operations of the method 900 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 905, the method may include receiving one or more reference signals using a collimator at the device having an aperture size sufficient to support simultaneous reception via a first beam corresponding to a first direction and at least a second beam corresponding to a second direction. The operations of 905 may be performed in accordance with examples as disclosed herein. In some examples, aspects of the operations of 905 may be performed by a reference signal manager 625 as described with reference to FIG. 6.

At 910, the method may include changing a direction of an illuminating beam to correspond to the first beam and at least the second beam over time during one or more measurement opportunities corresponding to the one or more reference signals. The operations of 910 may be performed in accordance with examples as disclosed herein. In some examples, aspects of the operations of 910 may be performed by a beam illumination manager 645 as described with reference to FIG. 6.

At 915, the method may include electronically performing one or more measurements for the one or more reference signals via the first beam and at least the second beam based on the aperture size of the collimator. The operations of 915 may be performed in accordance with examples as disclosed herein. In some examples, aspects of the operations of 915 may be performed by a beam measurement manager 630 as described with reference to FIG. 6.

At 920, the method may include determining a gradient of measurement improvement from the first direction to the second direction based on the one or more measurements, where mechanically adjusting the orientation of the device is based on the gradient of measurement improvement. The operations of 920 may be performed in accordance with examples as disclosed herein. In some examples, aspects of the operations of 920 may be performed by a beam measurement manager 630 as described with reference to FIG. 6.

At 925, the method may include mechanically adjusting an orientation of the collimator toward the second direction corresponding to the second beam based on the one or more measurements. The operations of 925 may be performed in accordance with examples as disclosed herein. In some examples, aspects of the operations of 925 may be performed by a mechanical adjustment manager 635 as described with reference to FIG. 6.

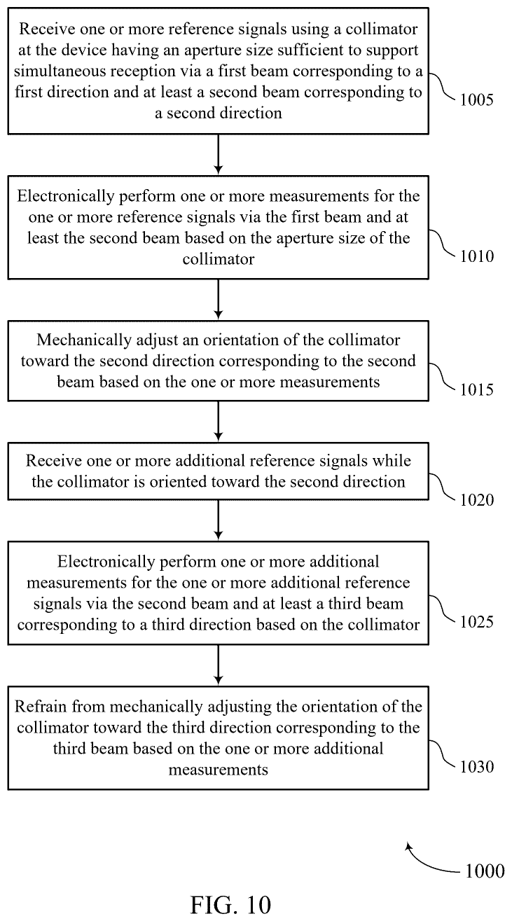

FIG. 10 shows a flowchart illustrating a method 1000 that supports fine tuning for collimator antenna devices in accordance with one or more aspects of the present disclosure. The operations of the method 1000 may be implemented by a wireless device or its components as described herein. For example, the operations of the method 1000 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 1005, the method may include receiving one or more reference signals using a collimator at the device having an aperture size sufficient to support simultaneous reception via a first beam corresponding to a first direction and at least a second beam corresponding to a second direction. The operations of 1005 may be performed in accordance with examples as disclosed herein. In some examples, aspects of the operations of 1005 may be performed by a reference signal manager 625 as described with reference to FIG. 6.

At 1010, the method may include electronically performing one or more measurements for the one or more reference signals via the first beam and at least the second beam based on the aperture size of the collimator. The operations of 1010 may be performed in accordance with examples as disclosed herein. In some examples, aspects of the operations of 1010 may be performed by a beam measurement manager 630 as described with reference to FIG. 6.

At 1015, the method may include mechanically adjusting an orientation of the collimator toward the second direction corresponding to the second beam based on the one or more measurements. The operations of 1015 may be performed in accordance with examples as disclosed herein. In some examples, aspects of the operations of 1015 may be performed by a mechanical adjustment manager 635 as described with reference to FIG. 6.

At 1020, the method may include receiving one or more additional reference signals while the collimator is oriented toward the second direction. The operations of 1020 may be performed in accordance with examples as disclosed herein. In some examples, aspects of the operations of 1020 may be performed by a reference signal manager 625 as described with reference to FIG. 6.

At 1025, the method may include electronically performing one or more additional measurements for the one or more additional reference signals via the second beam and at least a third beam corresponding to a third direction based on the collimator. The operations of 1025 may be performed in accordance with examples as disclosed herein. In some examples, aspects of the operations of 1025 may be performed by a beam measurement manager 630 as described with reference to FIG. 6.

At 1030, the method may include refraining from mechanically adjusting the orientation of the collimator toward the third direction corresponding to the third beam based on the one or more additional measurements. The operations of 1030 may be performed in accordance with examples as disclosed herein. In some examples, aspects of the operations of 1030 may be performed by a mechanical adjustment manager 635 as described with reference to FIG. 6.

The following provides an overview of aspects of the present disclosure:
Aspect 1: A method for wireless communications at a device, comprising:

receiving one or more reference signals using a collimator at the device having an aperture size sufficient to support simultaneous reception via a first beam corresponding to a first direction and at least a second beam corresponding to a second direction; electronically performing one or more measurements for the one or more reference signals via the first beam and at least the second beam based at least in part on the aperture size of the collimator; and mechanically adjusting an orientation of the collimator toward the second direction corresponding to the second beam based at least in part on the one or more measurements.
Aspect 2: The method of aspect 1, wherein mechanically adjusting the orientation of the collimator comprises: actuating a multi-axis rotating platform to rotate from a first position directed towards the first beam to a second position directed towards the second beam.
Aspect 3: The method of any of aspects 1 through 2, wherein receiving the one or more reference signals comprises: dithering an illuminating beam across the first beam and at least the second beam during a measurement opportunity corresponding to the one or more reference signals based at least in part on the aperture size of the collimator.
Aspect 4: The method of any of aspects 1 through 3, wherein electronically performing one or more measurements comprises: changing a direction of an illuminating beam to correspond to the first beam and at least the second beam over time during one or more measurement opportunities corresponding to the one or more reference signals; and determining a gradient of measurement improvement from the first direction to the second direction based at least in part on the one or more measurements, wherein mechanically adjusting the orientation of the device is based at least in part on the gradient of measurement improvement.
Aspect 5: The method of aspect 4, wherein the one or more measurements comprise reference signal receive power measurements.
Aspect 6: The method of any of aspects 4 through 5, wherein the gradient of measurement improvement comprises a set of measurement values, corresponding to respective beams of a plurality of beams, corresponding to the device resulting from the one or more measurements, and the set of measurement values improve when ordered from measurements corresponding to the first beam to measurements corresponding to the second beam.
Aspect 7: The method of any of aspects 4 through 6, wherein changing the direction of the illuminating beam comprises: steering the illuminating beam via one or more subsets of antenna elements an antenna array at the device.
Aspect 8: The method of any of aspects 1 through 7, wherein the one or more reference signals comprise one or more synchronization signal blocks, or one or more channel state information reference signals.
Aspect 9: The method of any of aspects 1 through 8, further comprising: receiving one or more additional reference signals while the collimator is oriented toward the second direction; electronically performing one or more additional measurements for the one or more additional reference signals via the second beam and at least a third beam corresponding to a third direction based at least in part on the collimator; and refraining from mechanically adjusting the orientation of the collimator toward the third direction corresponding to the third beam based at least in part on the one or more additional measurements.
Aspect 10: A device for wireless communications, comprising one or more memories storing processor-executable code, and one or more processors coupled with the one or more memories and individually or collectively operable to execute the code to cause the device to perform a method of any of aspects 1 through 9.
Aspect 11: A device for wireless communications, comprising at least one means for performing a method of any of aspects 1 through 9.
Aspect 12: A non-transitory computer-readable medium storing code for wireless communications, the code comprising instructions executable by one or more processors to perform a method of any of aspects 1 through 9.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device, comprising:
one or more memories storing processor-executable code; and
one or more processors coupled with the one or more memories and individually or collectively operable to execute the code to cause the device to:
receive one or more reference signals using a collimator at the device having an aperture size sufficient to support simultaneous reception via a first beam corresponding to a first direction and at least a second beam corresponding to a second direction;
electronically perform one or more measurements for the one or more reference signals via the first beam and at least the second beam based at least in part on the aperture size of the collimator; and
mechanically adjust an orientation of the collimator toward the second direction corresponding to the second beam based at least in part on the one or more measurements.

2. The device of claim 1, wherein, to mechanically adjust the orientation of the collimator, the one or more processors are individually or collectively operable to execute the code to cause the device to:
actuate a multi-axis rotating platform to rotate from a first position directed towards the first beam to a second position directed towards the second beam.

3. The device of claim 1, wherein, to receive the one or more reference signals, the one or more processors are individually or collectively operable to execute the code to cause the device to:
dither an illuminating beam across the first beam and at least the second beam during a measurement opportunity corresponding to the one or more reference signals based at least in part on the aperture size of the collimator.

4. The device of claim 1, wherein, to electronically perform one or more measurements, the one or more processors are individually or collectively operable to execute the code to cause the device to:
change a direction of an illuminating beam to correspond to the first beam and at least the second beam over time during one or more measurement opportunities corresponding to the one or more reference signals; and
determine a gradient of measurement improvement from the first direction to the second direction based at least in part on the one or more measurements, wherein mechanically adjusting the orientation of the device is based at least in part on the gradient of measurement improvement.

5. The device of claim 4, wherein:
the one or more measurements comprise reference signal receive power measurements.

6. The device of claim 4, wherein the gradient of measurement improvement comprises a set of measurement values, corresponding to respective beams of a plurality of beams, corresponding to the device resulting from the one or more measurements, and the set of measurement values improve when ordered from measurements corresponding to the first beam to measurements corresponding to the second beam.

7. The device of claim 4, wherein, to change the direction of the illuminating beam, the one or more processors are individually or collectively operable to execute the code to cause the device to:
steer the illuminating beam via one or more subsets of antenna elements an antenna array at the device.

8. The device of claim 1, wherein:
the one or more reference signals comprise one or more synchronization signal blocks, or one or more channel state information reference signals.

9. The device of claim 1, wherein the one or more processors are individually or collectively further operable to execute the code to cause the device to:
receive one or more additional reference signals while the collimator is oriented toward the second direction;
electronically perform one or more additional measurements for the one or more additional reference signals via the second beam and at least a third beam corresponding to a third direction based at least in part on the collimator; and
refrain from mechanically adjusting the orientation of the collimator toward the third direction corresponding to the third beam based at least in part on the one or more additional measurements.

10. A method for wireless communications at a device, comprising:
receiving one or more reference signals using a collimator at the device having an aperture size sufficient to support simultaneous reception via a first beam corresponding to a first direction and at least a second beam corresponding to a second direction;
electronically performing one or more measurements for the one or more reference signals via the first beam and at least the second beam based at least in part on the aperture size of the collimator; and
mechanically adjusting an orientation of the collimator toward the second direction corresponding to the second beam based at least in part on the one or more measurements.

11. The method of claim 10, wherein mechanically adjusting the orientation of the collimator comprises:
actuating a multi-axis rotating platform to rotate from a first position directed towards the first beam to a second position directed towards the second beam.

12. The method of claim 10, wherein receiving the one or more reference signals comprises:
dithering an illuminating beam across the first beam and at least the second beam during a measurement opportunity corresponding to the one or more reference signals based at least in part on the aperture size of the collimator.

13. The method of claim 10, wherein electronically performing one or more measurements comprises:
changing a direction of an illuminating beam to correspond to the first beam and at least the second beam over time during one or more measurement opportunities corresponding to the one or more reference signals; and
determining a gradient of measurement improvement from the first direction to the second direction based at least in part on the one or more measurements, wherein mechanically adjusting the orientation of the device is based at least in part on the gradient of measurement improvement.

14. The method of claim 13, wherein the one or more measurements comprise reference signal receive power measurements.

15. The method of claim 13, wherein the gradient of measurement improvement comprises a set of measurement values, corresponding to respective beams of a plurality of beams, corresponding to the device resulting from the one or more measurements, and the set of measurement values improve when ordered from measurements corresponding to the first beam to measurements corresponding to the second beam.

16. The method of claim 13, wherein changing the direction of the illuminating beam comprises:
steering the illuminating beam via one or more subsets of antenna elements an antenna array at the device.

17. The method of claim 10, wherein the one or more reference signals comprise one or more synchronization signal blocks, or one or more channel state information reference signals.

18. The method of claim 10, further comprising:
receiving one or more additional reference signals while the collimator is oriented toward the second direction;
electronically performing one or more additional measurements for the one or more additional reference signals via the second beam and at least a third beam corresponding to a third direction based at least in part on the collimator; and
refraining from mechanically adjusting the orientation of the collimator toward the third direction corresponding to the third beam based at least in part on the one or more additional measurements.

19. A non-transitory computer-readable medium storing code for wireless communications, the code comprising instructions executable by one or more processors at a wireless device to:
receive one or more reference signals using a collimator at the device having an aperture size sufficient to support simultaneous reception via a first beam corresponding to a first direction and at least a second beam corresponding to a second direction;
electronically perform one or more measurements for the one or more reference signals via the first beam and at least the second beam based at least in part on the aperture size of the collimator; and
mechanically adjust an orientation of the collimator toward the second direction corresponding to the second beam based at least in part on the one or more measurements.

20. The non-transitory computer-readable medium of claim 19, wherein the instructions to mechanically adjust the orientation of the collimator are executable by the one or more processors to:
actuate a multi-axis rotating platform to rotate from a first position directed towards the first beam to a second position directed towards the second beam.
